(19) United States
(12) Patent Application Publication
(10) Pub. No.: US 2015/0277978 A1
(43) Pub. Date: Oct. 1, 2015

(54) NETWORK PROCESSOR FOR MANAGING A PACKET PROCESSING ACCELERATION LOGIC CIRCUITRY IN A NETWORKING DEVICE

(71) Applicant: AVISHAY MOSCOVICI, TEL AVIV (IL)

(72) Inventor: AVISHAY MOSCOVICI, TEL AVIV (IL)

(73) Assignee: FREESCALE SEMICONDUCTOR, INC., Austin, TX (US)

(21) Appl. No.: 14/224,391

(22) Filed: Mar. 25, 2014

(51) Int. Cl. G06F 9/50; G06F 13/24; G06F 9/48

(52) U.S. Cl. CPC G06F 9/5011; G06F 9/4881; G06F 13/24

(57) ABSTRACT

The invention relates to a network processor for managing communication between a central processing unit running tasks on one or more partitions, and a PPA logic circuitry. Management portals pass messages to and from the central processing unit. A management portal communicates with one of the partitions. A resource state manager is arranged to manage resources of the PPA logic circuitry and to communicate states of the resources to the tasks via the management portals. A controller driver drives the PPA logic circuitry using information received from the resource state manager and the instructions from a data interface. The networking device does not need a separate master partition, and is allowing a programmer to deploy the system fast and with minimal risk or effort on different integrated systems.

### FIELD OF THE INVENTION

This invention relates to a network processor, an integrated circuit and a networking device comprising such an integrated circuit.

### BACKGROUND OF THE INVENTION

The Data Path Acceleration Architecture (DPAA) is a set of hardware components for the purpose of packet processing acceleration provided on specific QorIQ P and T series multicore network microprocessors as provided by the company Freescale Semiconductor, Inc. of Austin, Tex. 78735, USA. This architecture provides the infrastructure to support simplified sharing of networking interfaces and accelerators by multiple CPU cores, and the data-path accelerators (DPAs) themselves. QorIQ DPAA components may include Multicore infrastructure components such as the Queue Manager and Buffer Manager, Frame Manager for network I/O, Hardware accelerators for cryptography (SEC), regular expression scanning (PME) and compression (DCE).

Many current multi-core based processors make use of a packet processing acceleration (PPA) logic circuitry, such as the data-path accelerator mentioned above. Networking devices where such processors are used in are such as NIC (Network interface Card), Routers, Switches, wireless LAN access points and more. The networking devices of today are using a so-called General Purpose Processor (GPP) complex of multicore general purpose processing units for the purpose of to allow processing of high bandwidth traffic. A GPP complex may be made out of standard architectures such as ARM, PowerPC, or MIPS and allows the user of the networking device to program the networking device in a standard fashion, using standard tools, operating system and packages of software (SW).

The networking devices may use a packet processing acceleration logic circuitry that processes the traffic coming in and out of the networking device. The PPA logic circuitry is usually offloading operations such as packet header classification, encryption/decryption, packet header manipulation and more. In order to use effective hardware (HW) design the PPA logic circuitry may be shared by a plurality of tasks running over the GPP. The PPA logic circuitry may also be shared by multiple communication ports.

The common way of configuring, initializing, controlling during run time and handling exceptions of the PPA logic circuitry is by the creation of drivers that supply the specific procedures of the PPA logic circuitry on one hand and could be integrated to the Operating System running over the GPP. But since in the advanced networking case there are many partitions running over the many cores, there is a need to coordinate between the different entities. This is normally done by a master partition that holds the state of resources of the entire system. This also creates the need for IPC (Inter Partition Communication) which serves for the purpose of sending messages between the master partition and the slave partitions.

Each one of the partitions needs to have the ability to send and receive traffic from the PPA logic circuitry, but also to control the PPA logic circuitry per the unique needs of the partition such as updating routing tables, actions to be taken based on given flow and more.

Since a driver is operating in real time and is using the resources of each of the partitions in the system, the integration into the operating system has to take in account constraints of the system such as available MIPS (millions of instructions per second), memory allocations, latencies for operation and more.

There are several disadvantages in the solution of the prior art. First, the integration effort of the drivers into the rest of the system is high. This effort is taken usually by a system integrator and for each system, so when the OS is changing, or the way the partitions are assigned, this effort is repeated, i.e. there is no much of a reuse between different system integrations.

The risk of failures when integrating the drivers is high as a driver is not isolated from the rest of the system and as such is influenced from un-expected behaviour that might occur by untrusted SW. Since a PPA logic circuitry is centralized, one failing partition on the GPP may cause the failure of the entire system (i.e. all partitions).

### SUMMARY OF THE INVENTION

The present invention provides a network processor, an integrated circuit and a networking device as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale. In the Figures, elements which correspond to elements already described may have the same reference numerals.

FIG. 1 schematically shows a part of an integrated circuit for a networking device according to the state of the art;

FIG. 2 schematically shows an example of a network processor interacting with a CPU and a PPA, according to an embodiment;

FIG. 3 schematically shows an example of a possible hardware implementation of the network processor of FIG. 2, interacting with the CPU and the PPA logic circuitry;

FIG. 4 schematically shows the network processor of FIGS. 2 and 3, showing possible software functionality running over the array of processor cores;

FIG. 5 schematically shows an integrated circuit for a networking device according to a further aspect of the invention;

FIG. 6 schematically shows a networking device according to an embodiment of a further aspect of the invention.

### DETAILED DESCRIPTION OF THE PREFERRED EMBODIMENTS

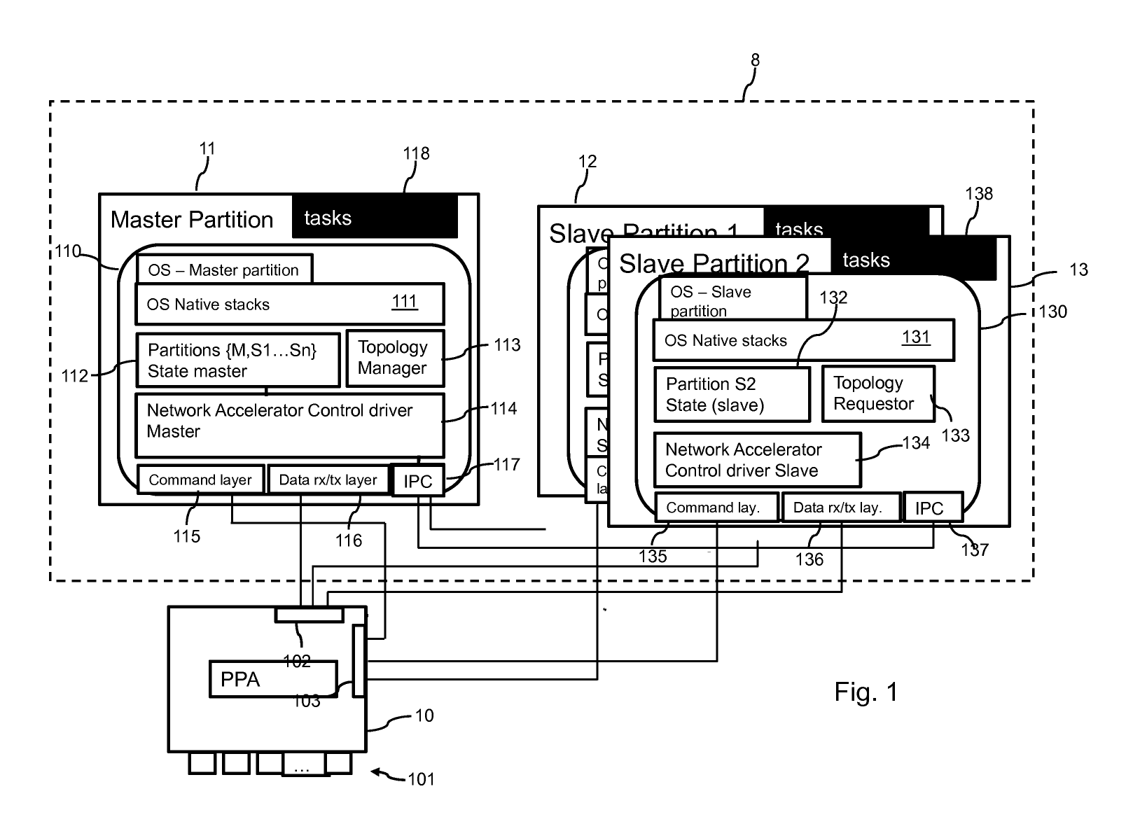

FIG. 1 schematically shows a part of a networking device according to the state of the art. The networking device comprises a CPU 8 and a PPA logic circuitry 10. The PPA logic circuitry 10 comprises a number of physical ports 101, a data interface 102 and a command interface 103.

The CPU 8 is partitioned so as to create a master partition 11 and in this example two slave partitions 12, 13. The CPU 8 may be embodied by one or more cores (also referred to as processing cores). On each of the partitions 11, 12, 13 an operating system (OS) is running, see e.g. the OS 110 on the master partition 11 and OS 130. The slave partition 12 is similar to the slave partition 13, and its components only partly visible in FIG. 1, and will not be referred to as such. Each of the OSs 110, 120, 130 uses its own OS native stacks, see 111 and 131. The master partition 11 comprises a partitions state manager 112 and also the slave partitions 12, 13 comprise their own partition state manager 132. On the master partition 11 a topology manager 113 is running, while on the slave partitions 12, 13 a topology requester 133 is running. On each partition 11, 12, 13 a network accelerator control driver is running, see 114, 134 respectively. Each of the partitions 11, 12, 13 uses its own command layer, see 115, 135 and its own data rx/tx layer, see 116, 136. Finally, each partition 11, 12, 13 uses its own inter-partition communication (IPC) module, see 117, 137. On each of the partitions 11, 12, 13 one or more software applications 118, 138 may run, also referred to as customer apps.

As can be seen from FIG. 1, the respective data rx/tx layers 116, 136 are connected to the data interface 102 of the PPA logic circuitry 10. The command layers 115, 135 are connected to the command interface 103 of the accelerator 10. The IPCs 137 of the slave partitions 12 and 13 are coupled to the IPC 117 of the master partition 11.

The partitions state manager 112 of the master partition 11 is responsible for the controlling and registration of the states of all the partitions. The partition state manager 132 of the slave partitions 12, 13 are responsible for the controlling and registration of the state of their own partition. The topology manager 113 is controlling the flow of data packets internally to the PPA logic circuitry 10 using resources available inside the PPA logic circuitry 10 and the different partitions 11, 12, 13 resulting in an overall data flow topology. The topology requestors 133 of the salve partitions 12, 13 will communicate with the topology manager 113 to ask the topology manager 113 to include topology requests of the slave partitions into the overall system topology. As such the partitions state manager 112 and the topology manager 113 are in charge of the resources of the entire system.

The customer applications may be created by one or more so-called system integrators who will implement their own applications using the CPU 8 and its development tools. These tools may cover a wide range of applications, but will force the system integrators to invest in complex development and system integration. A conventional way to enable the system integrators with high complexity acceleration designs is by providing a set of SW drivers that supply SW representation of the HW implementation. In order to allow generic usage of the accelerator, usually the control drivers 114, 134 provide a high degree of flexibility and thus are of high complexity.

The control drivers 114, 134 have to be integrated into the CPU 8 and as such may be exposed to other user's or system's unrelated components and may cause or suffer from conflicts that may cause the CPU 8 to crash in erroneous situations. Furthermore, running the acceleration drivers over the general purpose cores may use cycles and memory out of the general available resources intended for general applications which is not desirable.

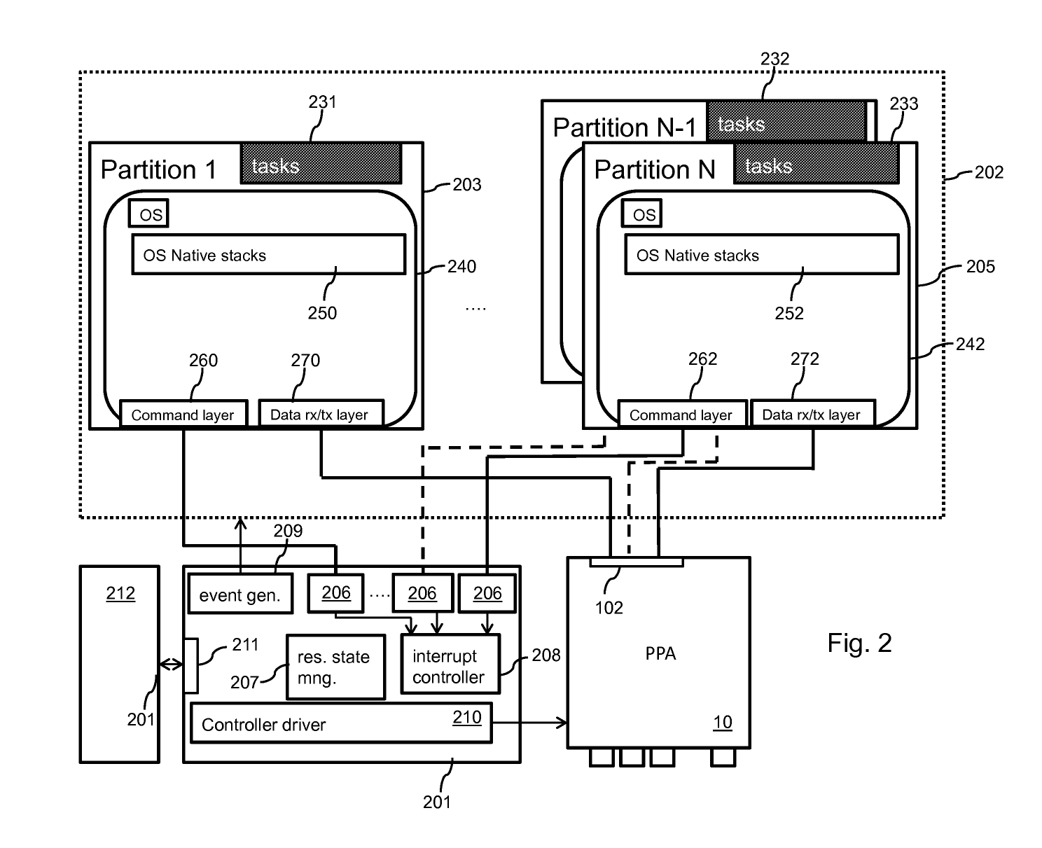

FIG. 2 schematically shows an example of a network processor 201 according to an embodiment. The network processor 201 is arranged for managing communication between a central processing unit (CPU) 202, at least in use, running one or more tasks on one or more partitions 203, 204, 205, and a PPA logic circuitry 10. The network processor 201 comprises a number of management portals 206 arranged to pass messages to and from the CPU 202. Each of the management portals is arranged to communicate with one of the tasks running on the CPU 202.

The network processor 201 comprises an interrupt controller 208 arranged to receive interrupt requests from the management portals 206 and to receive event messages from the PPA logic circuitry 10. Furthermore, the network processor 201 comprises a resource state manager 207 arranged to manage resources of the PPA logic circuitry 10 and to communicate states of the resources to the tasks via the management portals 206. The network processor 201 also comprises a data interface 211 arranged to read instructions from a private memory 212, and a controller driver 210 arranged to drive the PPA logic circuitry 10 using information received from the resource state manager 207 and the instructions from the data interface 211.

In FIG. 2 only three partitions 203, 204, 205 out of N partitions are shown. FIG. 2 shows that on each of the partitions 203, 204, 205 an OS is running, see OS 240, 242 using respective OS native stacks 250, 252. On each of the partitions 203, 204, 205, one or more tasks are running, see 231, 232, 233.

Each of the partitions 203, 204, 205 comprises a command layer, see 260, 270, and a data rx/tx layer, see 270, 272. The partitions 203, 204, 205 communicate with the management portals 206 via their command layers 260, 270, and communicate with the data interface 102 of the PPA 10 via their data rx/tx layers 270, 272. In FIG. 2, the components of the partition 204 are hidden behind the partition 205. This partition 204 communicates in a similar way with the management portals 206 and the PPA 10, see dashed lines.

The network processor 201 is offloading the PPA resource management and the control driver operations from the CPU 202. So there is no need for a resource state manager in any of the partitions 203, 204, 205, and no need for a control driver in these partitions. So the PPA operation is no longer forcing the partitioning of the CPU 202 into master and slaves partitions and there is no need for IPC (Inter Partition Communication).

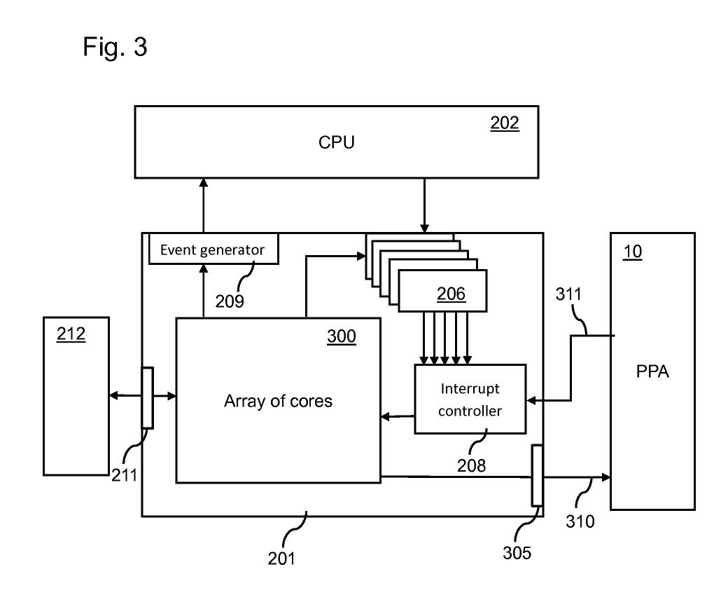

FIG. 3 schematically shows an example of a possible hardware implementation of the network processor 201 of FIG. 2, interacting with the CPU 202 and the PPA logic circuitry 10. The network processor 201 comprises the data interface 211 arranged to communicate with the private data memory 212. The private memory 212 is isolated and can only be accessed by the network processor 201 to allow trusted SW to run. The network processor 201 also comprises an array processing cores 300, the management portals 206 and the interrupt controller 208. Furthermore the network processor 201 comprises the event generator 209. The event generator 209 may comprise one or more registers where each one of the bits that compose the registers represent an event. The bits representing the events may be written by the control drivers running over the processor cores 300 based on the computation outcome of these drivers. The registers may be s set by the array of processor cores 300 when SW running over the network processor 201 decides to propagate an event to the CPU 202 via interrupt. Such an event may be an error or an exception and low latency event which the applications (i.e. tasks) running over the CPU 202 should be aware of.

The event generator 209 may also be accessed by the CPU 202 and read in poling mode (non-interrupt). CPU access to the event generator 209 allows an interrupt to be reset after/while it was serviced. The event generator 209 serves the communication between the CPU 202 and the network processor 201, e.g. a command may be sent by the CPU 202 to the network processor 201 to perform an operation. Once the operation is done by the network processor 201, the network processor 201 will communicate back to the CPU 201 the result of the operation: done; failed; etc. The communication back to the CPU 201 may be done by the event manager 209.

The array of processor cores 300 is arranged to access the private data memory 212 via the data interface 211 to allow secure/trusted SW isolation from the CPU 202. The network processor 201 may have access via an interface 305 to a system internal bus 310 that accesses a register space of the PPA 10 and by that could configure, initialize and manage the operation of the PPA 10. For example, the PPA 10 can signal events to the network processor 201 (such as errors, completion of tasks etc.) by interrupt signals that are marked as PPA events, see connection 311 in FIG. 3. These interrupt signals are input to the interrupt controller 208 on the network processor 201.

In the example of FIG. 3 the network processor connectivity to the CPU 202 is done by the event generator 209 which resides on the network processor 201 and is arranged to signal the CPU 202 for any asynchronous event which might occur in the network processor 201 or in the PPA 10. In this context asynchronous events are events which are not a direct result of the operations of the network processor 201 and can occur at any given time. Examples of asynchronous events are: physical connectivity drop, error propagated by wrong reception of a frame of information. Asynchronous errors internally to the network processor 201 may be: memory failure as ECC error or bus error. These errors are either propagated to the CPU 202 through the event generator 209 for purpose of notification or higher level action, As an example: error of physical connection disconnect on the PPA 10 will be propagated to the CPU 202 to allow tasks using the physical ports to react accordingly (shut down, wait, request usage of different port).

The CPU 202 will send messages and commands to the management portals 206. The interrupt controller 208 will then generate an interrupt to the array of processor cores 300 of the network processor 201 once a specific entry is written to the management portal memory.

In an embodiment the management portal is composed of several registers that hold the information of the command issued by the CPU to the network processor 201, one of the bits (i.e. position) in one of these registers is used as an interrupt generator, i.e. when this bit is written with a certain value a source of interrupt will be asserted. By using such a mechanism of management portals for communication and message passing between the CPU 202 and the network processor 201, different SW entities (i.e. tasks) on the CPU 202 can independently access the network processor 201 and can be served orthogonally. The number of management portals determines the different SW entities that can be served concurrently.

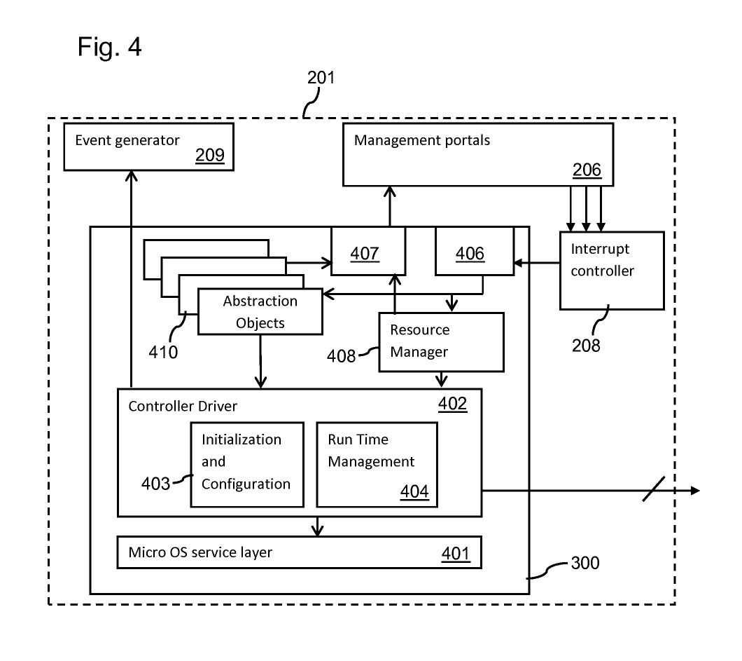

FIG. 4 schematically shows the network processor 201 of FIGS. 2 and 3, showing possible software functionality running over the array of processor cores 300. The software running over the array of processor cores 300 of the network processor 201 may include a micro OS service layer 401 which provides services and utilities to upper running SW layers such as memory allocation, trace, interrupt controller control (not shown). A controller driver 402 is shown which comprises a set of entities which are aware of all the intimate details of the PPA 10 and deals with the complexity of the initialization and management of the PPA 10.

In FIG. 4 an embodiment is shown wherein the controller driver 402 comprises an initialization-and-configuration block 403 arranged to setup the packet processing acceleration logic circuitry according to a central processing unit desired mode of operation. The controller driver 402 further comprises a run time management block 404 arranged to update data structures of the packet processing acceleration logic circuitry according to a network condition as communicated by the CPU 202. The initialization-and-configuration block 403 is arranged to initialize the PPA 10 to operate according to a desired configuration propagated through the networking processor 201. For example, a physical port may support an optional auto-negotiation scheme. The initialization-and-configuration block 403 is arranged to propagate the desired configuration; so such a feature will be enabled or disabled accordingly. The run-time management block 404 is arranged to update the PPA 10 based on run-time conditions, as an example if a look up table needs to be updated and modified to reflect a new network condition, the run-time configuration block 404 may execute the procedure required by the PPA 10 for such a change to be done properly.

The controller driver 402 is using the HW access of the network processor 201 to the register file bus 310, for the purpose of PPA control and management. Once the system boots the process of initialization starts and management follows.

The connectivity to the CPU 202, see also FIG. 3, is done by a command dispatch module 406 and a command response module 407. These modules may use management portals and event generator HW sub-blocks for the purpose of getting service requests from the CPU 202 and acknowledge execution, error and exceptions. An interrupt generated by a write of the CPU 202 to the management portal(s) 206 will trigger the execution of a task on the network processor 201. An example for such a task on the network processor 201 could be ‘device discover’ where the network processor 201 gives the CPU 202 the information regarding the available services of the PPA 10. Another example could be creation of a new security association based on information (eg: security key) coming from the CPU. After the last change is performed the PPA 10 will be supporting this new security association.

In this example a resource state manager 408 is running on the array of processor cores 300. It is responsible for the state management of the system and the resources allocation so as to allow virtualization of the PPA resources for the CPU 202. So in practice the CPU 202 views the virtual resources and is shielded from the need to probe the exact physical resources of the system (i.e. the PPA resources). An example of a PPA resource are the physical ports 101; these sources are very limited, but still could be assigned in a virtualized fashion. Virtualized refers to the fact that the user over the CPU 202 does not have to be aware of the exact location (address space wise) of the physical port, or its exact capabilities. The user needs to ask for a port and gets one based on the properties requested. Other examples of resources are buffer pools and queues.

On the array of processor cores 300 a number of so-called abstraction objects 410 may be loaded or created. These abstraction objects 410 are responsible for the actual interaction of the CPU 202 with the PPA 10. The interaction may for example be done through suitable defined APIs which can streamline terminology describing the features and attributes needed from the PPA 10. These abstraction objects may be called by the tasks 231, 232, 233 running over the CPU 202 using an API (Application Programming Interface), one or more parameters and SW data structures.

These APIs will not need the use of terminology or the specificity of the PPA HW implementation. The terminology used in the API may be known to high level SW object users. As such the API that is exposed to the higher level SW objects running over the CPU 202 may contain terminology such as “VLAN add operation”, known to any of the skilled person in the networking arena, rather than NIA—header manipulation, which is a specific HW implementation on the PPA stands for Next Invoked Action (NIA) to be header manipulation (general function) in the form of specific VLAN add operation, which is known to a skilled person knowing the exact details of the specific HW implementation of the PPA.

The provided solution is using HW entities which consist of cores and management portals which are isolated from the user system (i.e. the CPU 202). By the fact the user system is isolated the risk of undesired effects in the CPU 202 that may cause the PPA 10 to hung or operate wrongly, caused by erroneous operations such as applications writing over PPA allocated memory that are the result of un-trusted SW running over the CPU 202 is eliminated.

The network processor 201 is running a resource state manager, see 408, and interacts with the different partitions 203, 204, 205 via the management portals 206 such that any partition or task in the system (i.e. the CPU 202) is allocated its own interface which is virtualized by the SW running over the network processor 201.

The resource state manager 408 may be used for:
allocation (and de-allocation) of resources to different software tasks,
managing and tracking ownership of resources,
supporting hierarchical resource management—enabling a CPU software task to create child tasks and to assign any subset of its PPA resources to its child tasks,
supporting flexibility in creating and assigning resources—resource management may be static or dynamic, resources may be assigned or requested, and/or
supporting policy mechanisms that allow parent software tasks to control the resource management capabilities of their children.

The resource state manager 408 may be used by the abstraction objects 410 any time such object is invoked and when such object is freed and the resources may get back to the resource pool. The resource state manager 408 may also be used as part of a fail-over mechanism when a partition needs to resume. The resource state manager 408 may be used at the initial phase where the CPU 202 is running a device discovery operation after the boot of the system, during that time the resource state manager 408 will be requested to report the content of the capabilities and resources available for use.

Since a management portal is exclusive to a particular SW task running over the CPU 202, a SW abstraction layer composed of abstraction objects running over the network processor 201 may be added which can streamline the interface of the SW running over the CPU 202 to achieve a standard interface such as either industry standard or de-facto standard (eg: NIC interface, Virtual Switch interface).

In an embodiment, a number of abstraction objects are created which are arranged to interact with the tasks running over the CPU 202 for the purpose of resource discovery scheme, resource assignment, and/or networking interface creation (such as NIC—Network Interface Card and L2 Switch). Furthermore, the abstraction objects may be arranged for defining relations between physical resources and virtual resources such as LAG (Link aggregation) which uses multiple physical connections for the purpose of single virtual connection. Also abstract objects may be creates for the multiplexing of the physical data into several virtual entities.

The abstraction objects 410 enable an effortless migration into a new HW evolution of the PPA logic circuitry 10 as the interface remains standard, and the only portion which may change is in the network processor 201, once for all system integrations.

The PPA 10 may be composed of large number of primitives that upon configuration will compose the desired networking function. Examples of such primitives are: a frame header parser, frame queues, work queues, security engine, and a policer.

The abstraction objects 410 of the network processor 201 may be used for the purpose of representing a collective view of the primitives that compose the PPA 10. The collective view, supplied by the abstraction objects to the applications (i.e. tasks) running over the CPU 202 is collected by the user responsible for the integrated SW over the CPU 202 to a logical view of a Networking Interface. In this context a Networking interface is an interface of the application to standard networking services such as: NIC (network interface card, which supplies Ethernet interface) or L2 Switch which has the capability to analyze data frame addresses and route the frames between local area networks.

Some examples for the logical view (i.e. abstraction objects) are:

DPNI—Data Path Networking Interface has a NIC (Network Interface Card) version which is a standard interface as expected by a standard networking stack (like native Linux stack). A basic NIC may offer services like time stamping, filters, Quality of Service etc. More advanced NICs may offer services such as encryption/decryption, fragmentation/reassembly etc.

DPMUX—provides the network logics for the purpose of partitioning the traffic of a physical interface between SW entities.

DPLAG—A logic interface for the purpose of link aggregation—usage of several links for a single logical traffic pipe.

The invention may be used in multiple networking applications where a high traffic rate is required and the usage of multi partitions is needed. The amount of possible applications is large and varies from plain routers, wireless LAN access point and control point to Data centres and wireless base stations where there is a need to process the transport layer. The invention is applicable to all the devices using centralized data path processing which is shared by multiple partitions.

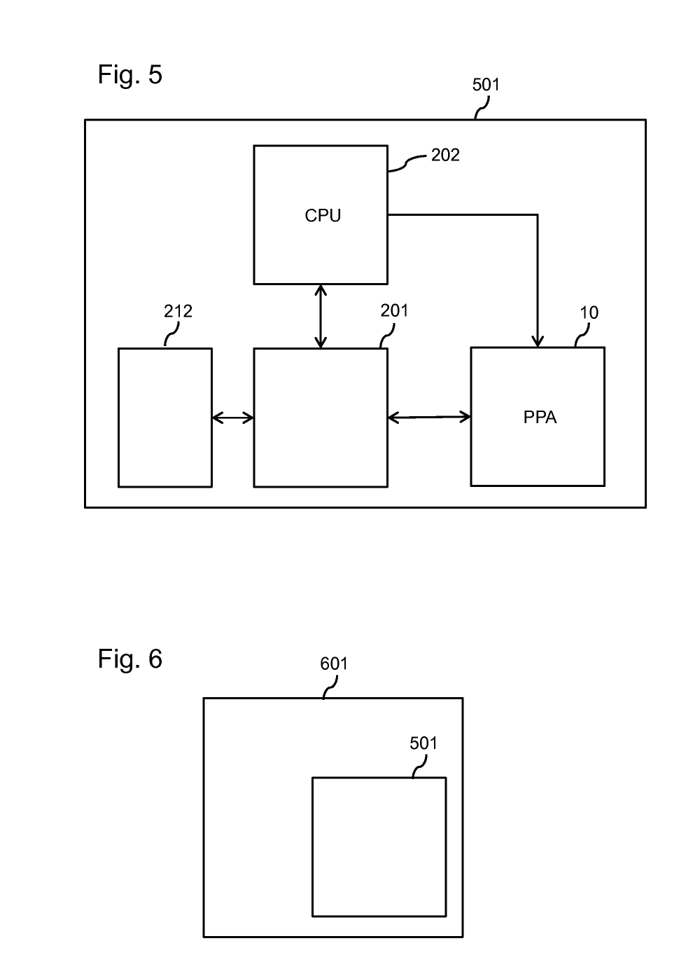

FIG. 5 schematically shows an integrated circuit 501 for use in a networking device according to a further aspect of the invention. The integrated circuit 501 comprises the CPU 202 as described above, at least in use running one or more tasks on one or more partitions. The network device also comprises the PPA logic circuitry 10 as described above, coupled to the central processing unit 202. A network processor 201 is arranged for managing communication between the central processing unit 202 and the PPA logic circuitry 10. A private memory 212 is coupled to the network processor 201 for storing instructions to be performed on the network processor 201. The network processor 201 may comprise the components and/or functionality described with reference to FIGS. 2, 3 and 4.

According to a further aspect a networking device is provided comprising an integrated ciruit as described above. FIG. 6 schematically shows an example of such a networking device 601 comprising the integrated circuit 501 as shown in FIG. 5. The networking device 601 may be a Network interface Card, a Router, a Switch, a wireless LAN access points, or any other networking device using a PPA logic circuitry.

Because the modules implementing the present invention are, for the most part, composed of electronic components and circuits known to those skilled in the art, circuit details will not be explained in any greater extent than that considered necessary as illustrated above, for the understanding and appreciation of the underlying concepts of the present invention and in order not to obfuscate or distract from the teachings of the present invention.

Those skilled in the art will recognize that boundaries between the functionality of the above described operations merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

In the claims, any reference signs placed between parentheses shall not be construed as limiting the claim. The word ‘comprising’ does not exclude the presence of other elements or steps then those listed in a claim. Furthermore, Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or an limits any particular claim containing such introduced claim element to inventions containing only one such element, even when the same claim includes the introductory phrases one or more or at least one and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. Network processor for managing communication between a central processing unit at least in use running one or more tasks on one or more partitions, and a packet processing acceleration logic circuitry, the network processor comprising:
a number of management portals arranged to pass messages to and from the central processing unit, each of the management portals being arranged to communicate with one of the tasks running on the central processing unit;
a resource state manager arranged to manage resources of the packet processing acceleration logic circuitry and to communicate states of the resources to the one or more tasks via the management portals;
a data interface arranged to read instructions from a private memory;
a controller driver arranged to drive the packet processing acceleration logic circuitry using information received from the resource state manager and the instructions from the data interface.

2. Network processor according to claim 1, wherein the network processor comprises an interrupt controller arranged to receive interrupt requests from the management portals and to receive event messages from the packet processing acceleration logic circuitry.

3. Network processor according to claim 1, wherein the network processor comprising:
an array of processor cores arranged to load an operating system,
an event generator arranged to collect events from the control driver and from the operating system and to send signals to the central processing unit relating to any asynchronous event which may occur in the network processor or in the packet processing acceleration logic circuitry.

4. Network processor according to claim 1, wherein the controller driver comprises an initialization-and-configuration block arranged to setup the packet processing acceleration logic circuitry according to a central processing unit desired mode of operation, and a run time management block arranged to update data structures of the packet processing acceleration logic circuitry according to a network condition as communicated by the central processing unit.

5. Network processor according to claim 1, wherein each of the management portals comprises a number of registers that hold information on commands issued by the CPU to the network processor.

6. Network processor according to claim 5, wherein one position in one of the registers is used as an interrupt generator, wherein a source of interrupt will be asserted if a certain value is written to the position.

7. Network processor according to claim 1, wherein the resource state manager is arranged for allocation (and de-allocation) of resources to different software tasks.

8. Network processor according to claim 1, wherein the resource state manager is arranged for managing and tracking ownership of resources.

9. Network processor according to claim 1, wherein the resource state manager is arranged for supporting hierarchical resource management, so as to enable the tasks to create child tasks and to assign any subset of its PPA resources to its child tasks.

10. Network processor according to claim 1, wherein the resource state manager is arranged for supporting flexibility in creating and assigning resources.

11. Network processor according to claim 1, wherein the resource state manager is arranged for supporting policy mechanisms that allow parent software tasks to control the resource management capabilities of their children.

12. Network processor according to claim 1, wherein the network processor comprises one or more internal processing cores arranged to:
receive the instructions from the data interface;
receive state information from the resource state manager;
execute the controller driver using the instructions and the state information.

13. Network processor according to claim 12, wherein the one or more internal processing cores are arranged to create a number of abstraction objects arranged to interact with the tasks running over the central processing unit for the purpose of at least one of the following:
resource discovery scheme,
resource assignment,
networking interface creation,
definition of relations between physical resource and virtual resources, such as link aggregation, and
multiplexing of the physical data into several virtual entities.

14. Integrated circuit comprising:
a central processing unit, at least in use running one or more tasks on one or more partitions,
a packet processing acceleration logic circuitry coupled to the central processing unit,
a network processor for managing communication between the central processing unit and the packet processing acceleration logic circuitry,
a private memory coupled to the network processor for storing instructions to be performed on the network processor;
the network processor comprising:
a number of management portals arranged to pass messages to and from the central processing unit, each of the management portals being arranged to communicate with one of the tasks running on the central processing unit;
a resource state manager arranged to manage resources of the packet processing acceleration logic circuitry and to communicate states of the resources to the one or more tasks via the management portals;
a data interface arranged to read instructions from the private memory;
a controller driver arranged to drive the packet processing acceleration logic circuitry using information received from the resource state manager and the instructions from the data interface.

15. Networking device comprising an integrated circuit according to claim 14.

16. Networking device according to claim 15, the device being one out of:
a Network interface Card,
a Router,
a Switch,
a wireless LAN access points.
